(19) United States
(12) Patent Application Publication
(10) Pub. No.: US 2015/0155588 A1
(43) Pub. Date: Jun. 4, 2015

(54) LITHIUM BATTERY ASSEMBLY METHOD, ASSEMBLY SYSTEM AND POSITIVE AND NEGATIVE HOMOPOLAR EXPLOSION-PROOF LITHIUM BATTERY

(71) Applicant: Muxin LU, Shenzhen (CN)

(72) Inventor: Muxin LU, Shenzhen (CN)

(21) Appl. No.: 14/095,228

(22) Filed: Dec. 3, 2013

(51) Int. Cl. H01M 10/04; H01M 2/06

(52) U.S. Cl. CPC H01M 10/0409; H01M 2/06

(57) ABSTRACT

A lithium battery assembly method includes an assembly system and a positive and negative homopolar explosion-proof lithium battery, wherein an electrode assembly system, a combining system and a sealing system are arranged; guide pins are corrected and hence enter pre-punched holes of a nailing area to achieve nailing; after foil paper is subjected to primary foil pulling, flattening, secondary foil pulling and foiling, tails of the guide pins after ejection are wound, and synchronous lamination, paper cutting, gumming and output are performed; an aluminum shell is fixedly connected with the positioned guide pins and forced by program control to form a battery body structure; the battery body structure is sleeved into a tubular gel according to the setting scale of a control device; and the displacement and the moving cycle are calibrated by a servo control system, so as to control a sealing machine to achieve port sealing.

### FIELD OF THE INVENTION

The present invention relates to the technical field of lithium batteries, in particular to a lithium battery assembly method and an assembly system.

### BACKGROUND OF THE INVENTION

Currently, the main structure of a cylindrical lithium battery is as follows: a positive electrode contact and an insulating ring plate are disposed at the bottom; an insulation sheet, an insulation ring, a protective board provided with a protective circuit, and a negative electrode contact are disposed at the other end of the lithium battery in sequence; a positive strap is arranged; one end of the positive strap is electrically connected with the positive electrode contact and the other end is connected with a positive electrode output end of the protective circuit; a negative strap is arranged; one end of the negative strap is connected with a negative electrode of the protective circuit and the other end is connected with a negative electrode of the lithium battery; an insulating protective layer is arranged and configured to wrap the above members to be integrated into a whole; openings are formed at both ends of the protective layer; and the positive electrode contact and the negative electrode contact are disposed at the openings.

The traditional lithium battery and the currently available cylindrical lithium battery are generally made of external packing materials such as stainless steel and aluminum alloy. In general, the cylindrical lithium battery takes a protruded head at one end as a positive electrode and a shell as a negative electrode. As a positive electrode and a negative electrode of the lithium battery are close to each other, tools such as screwdrivers and tweezers tend to come into contact with the two electrodes of the lithium battery due to carelessness during the installation and maintenance, and hence the short circuit can be caused by the connection of the two electrodes, and consequently the lithium battery can be damaged. Moreover, the cylindrical lithium battery with the structure also has the defects of difficult electrolyte injection, low tightness of battery sealing and easy leakage. In addition, as a seal of the cylindrical lithium battery is an integral seal, the cylindrical lithium battery does not have the explosion-proof function in the case that the lithium battery is damaged and explodes, resulting in very serious security risk.

### SUMMARY OF THE INVENTION

The objective of the present invention is to provide a lithium battery assembly method and an assembly system. The prevent invention adopts the systematic production mode, and not only saves the resources such as the materials but also saves a large amount of processing time and effectively improves the production efficiency of products via the coherent operations of various assembly systems. Moreover, the assembly system provided by the present invention has high automation degree and achieves data coupling and synchronous operation through control systems of various manufacturing processes, so that the process continuity can be strong, and hence the product quality can be effectively improved. Furthermore, the appearance and the dimension of products are flexibly set and the technological parameters are quickly converted in view of different application fields, so that the range of use of the products can be maximally widened.

In order to effectively solve the above problem, the technical proposal adopted by the present invention is that:

The present invention relates to a lithium battery assembly method, which comprises the following steps of:

(1) arrangement of an assembly system: the assembly system consists of an electrode assembly system, a combining system and a sealing system;

(2) ejection: the electrode assembly system comprises a nailing machine and a nailing machine control module which are configured to correct guide pins and drive the guide pins to enter pre-punched holes of a nailing area to achieve nailing;

(3) winding: the electrode assembly system further comprises a winder and a winder control module which are configured to perform primary foil pulling, flattening, secondary foil pulling and foiling on foil paper, wind the tail of the guide pins after ejection, and perform synchronous lamination, paper cutting, gumming and output;

(4) assembly: the combining system comprises a combiner and a combining controller; an aluminum shell is fixedly connected with the positioned guide pins and hence forced by program control; the guide pins are extended horizontally to form an electrode; and the seamless fixed connection between the guide pins and the aluminum shell is achieved to form a battery body structure; and

(5) sealing: the sealing system comprises a sleeve device and a sealing machine and further comprises a full-servo control system and a control device; the battery body structure is sleeved into a tubular gel according to the setting scale of the control device; and the displacement and the moving cycle are calibrated by the servo control system to control the sealing machine to achieve port sealing.

Particularly, the step (1) further comprises the following steps that: a guided transmission device of the electrode assembly system is connected with an automatic feeding device of the combining system; and a feeding channel and a transmission member of the sealing system are connected with the combining system to achieve the process control.

Particularly, the step (2) further comprises the following steps that:

the nailing machine is also provided with an automatic feed tray to achieve continuous feed and transmission, and a sliding track to achieve the transmission of the guide pins, in which the sliding tack is an adhesive tape; a punch unit is arranged to punch the tails of the guide pins which are hence fixed on a transfer tape; the winder is configured to stack and wind welded positive and negative pole pieces to form a rectangular bare battery core; and an insulating membrane is padded between the positive and negative pole pieces.

Particularly, the step (3) further comprises the following steps that:

the winder is provided with a turning and swinging mechanism configured to achieve the pushing transmission of the guide pins, an automatic transfer mechanism configured to achieve the nailing transmission of the guide pins, and an intermediate template configured to achieve the pressing processing of the guide pins and the discharging of nailing pieces and perform foiling, foil feeding and winding on a nailing conjoining body directly or before the discharging.

Particularly, the step (4) further comprises the following steps that:

the combiner is provided with a multi-inlet feeding end, a feeding channel and a transmission member configured to respectively achieve the feeding of the aluminum shell and the feeding of an inner core, a plurality of feeding contacts, an execution unit configured to allocate the obtained product to the same executing mechanism through a synchronous control terminal; and hence the synchronous assembly molding can be achieved.

Particularly, the step (5) further comprises the following steps that:

after the sleeve device achieves automatic feeding via an external vibration table, the embedded processing of a sleeve is performed, and the obtained product is sent to an impregnation executing terminal, subjected to vacuum pumping and hence outputted; the sealing machine is provided with a seal on the outside to achieve sealing; the seal is a rubber explosion-proof body; and a small hole through which the electrode penetrates is formed on the explosion-proof body.

The present invention relates to an assembly system for achieving the foregoing assembly method, which comprises an electrode assembly system, a combining system and a sealing system, wherein a guided transmission device of the electrode assembly system is connected with an automatic feeding device of the combining system; and a feed channel and a transmission member of the sealing system are connected with the combining system to achieve process control.

Particularly, the electrode assembly system further comprises:

(1) a nailing machine and a nailing machine control module which are configured to deliver guide pins into a linear feeding track and a pushing track in sequence, correct the guide pins and drive the guide pins to enter pre-punched holes of a nailing area to achieve nailing;

(2) a winder and a winder control module which are configured to perform primary foil pulling, flattening, secondary foil pulling and foiling on foil paper, winding tails of the guide pins after ejection, and perform synchronous lamination, paper cutting, gumming and output;

(3) a punch unit configured to punch the tails of the guide pins which are hence fixed on a transfer tape;

(4) a control interface configured to achieve the setting, display and clear of parameters of the nailing machine and provided with a text interface and a numeric keypad;

(5) a turning and swinging mechanism configured to achieve the pushing transmission of the guide pins; an automatic transfer mechanism configured to achieve the nailing transmission; and an intermediate template configured to achieve the pressing processing of the guide pins and the discharging of nailing pieces.

Particularly, the combining system further comprises:

(1) a combiner and a combining controller which are configured to achieve the fixed connection and forcing of an aluminum shell and the positioned guide pins by program control so as to form a battery body structure; and

(2) a feeding end configured to achieve the simultaneous feeding of a plurality of ports at the feeding end, with same cycle, in which the feeding end further includes a feed tray, a steel sheet and a support of which the resonance value of the resonance frequency at the maximum amplitude is the same with the magnetic resonance frequency of an electric power source.

Particularly, the sealing system further comprises:

(1) a sleeve device and a sealing machine for respectively achieving sleeved arrangement and sealing;

(2) a controller for driving the battery body structure to be sleeved into a tubular gel according to the setting scale;

(3) a full-servo control system for calibrating the displacement and the moving cycle to control the sealing machine to achieve port sealing;

(4) a vibration linear feeding controller for restricting the safe range of the displacement and dimension parameters, in which the vibration linear feeding controller further includes an early warning module and a fault detection module configured to drive the combining system to achieve automatic early warning and stop operating after fault detection.

The present invention relates to a positive and negative homopolar explosion-proof lithium battery in the foregoing method, which comprises a battery body, wherein the body consists of an aluminum shell disposed on the outside and a battery core and electrolyte disposed on the inside; an outwardly extended electrode is disposed on the battery core; a rubber stopper is disposed at an opening of the aluminum shell; the electrode penetrates through the rubber stopper; and the electrode consists of two linearly arranged guide pins which are homopolarly and outwardly extended.

Particularly, the rubber stopper is provided with not less than two through holes; a seal waist of the battery core is disposed on the upper part of the aluminum shell; the rubber stopper is disposed between the seal waist and an opening at the upper end of the aluminum shell; the rubber stopper is matched with an independent sleeve, and the shape of the rubber stopper is matched with the shape of the sleeve; and the rubber stopper is configured to seal the sleeve through the static friction between the inner wall of the sleeve and the rubber stopper.

The prevent invention has the advantages that: the lithium battery assembly method provided by the present invention adopts the systematic production mode, and not only saves the resources such as the materials but also saves a large amount of processing time and effectively improves the production efficiency of products via the coherent operations of various assembly systems. Moreover, the assembly system provided by the present invention has high automation degree and achieves data coupling and synchronous operation through control systems of various manufacturing processes, so that the process continuity can be strong, and hence the product quality can be effectively improved. Furthermore, the appearance and the dimension of products are flexibly set and the technological parameters are quickly converted in view of different application fields, so that the range of use of the products can be maximally widened. In the present invention, as the accessories of cylindrical lithium battery products are precisely combined and the bonding of products and the molding space limit of the main body overcome the extruding defect of the traditional products, the safety hazards such as burning and bursting can be effectively avoided; and as no explosion-proof device is required and only the structure is required to be improved, no production cost and production cycle can be increased. In the positive and negative homopolar explosion-proof lithium battery provided by the present invention, the guide pins which are homopolarly led out from the positive electrode and the negative electrode of the cylindrical lithium ion battery are led out from the guide pin through holes of the rubber stopper disposed on the end portion of the battery, so that the guide pins can be fixed and the short circuit caused by the collision of the positive electrode and the negative electrode can be avoided. In addition, the seal of the rubber stopper made of rubber materials is also conducive to battery sealing after electrolyte injection, and hence the electrical conductivity of the cylindrical lithium ion battery can be guaranteed and the tightness can be also greatly improved. As the rubber stopper is disposed between the seal waist of the aluminum shell and the opening at the upper end of the shell and the two positive and negative guide pins connected to the battery core are led out from the guide pin through holes of the rubber stopper, the guide pins can be fixed and the short circuit caused by the collision of the positive electrode and the negative electrode can be avoided. In addition, the seal of the rubber stopper made of rubber materials is also conducive to battery packing after electrolyte injection, and hence the electrical conductivity and the tightness of the cylindrical lithium ion battery can be guaranteed and the product quality can be also greatly improved.

Detailed description will be given below to the present invention with reference to the accompanying drawings.

### BRIEF DESCRIPTION OF THE DRAWINGS

FIG. 1 is a schematic structural view illustrating the composition of an assembly system provided by the present invention;

FIG. 2 is a schematic structural view illustrating the composition of an electrode assembly system of the present invention;

FIG. 3 is a schematic structural view illustrating the composition of a combining system of the present invention;

FIG. 4 is a schematic structural view illustrating the composition of a sealing system of the present invention;

FIG. 5 is a flowchart of an assembly method provided by the present invention;

FIG. 6 is a schematic structural view illustrating the composition of a positive and negative homopolar explosion-proof lithium battery provided by the present invention;

FIG. 7 is a structural view of the positive and negative homopolar explosion-proof lithium battery provided by the present invention; and

FIG. 8 is a schematic structural view of a rubber stopper of the present invention.

### DETAILED DESCRIPTION OF THE PREFERRED EMBODIMENTS

### Embodiment 1

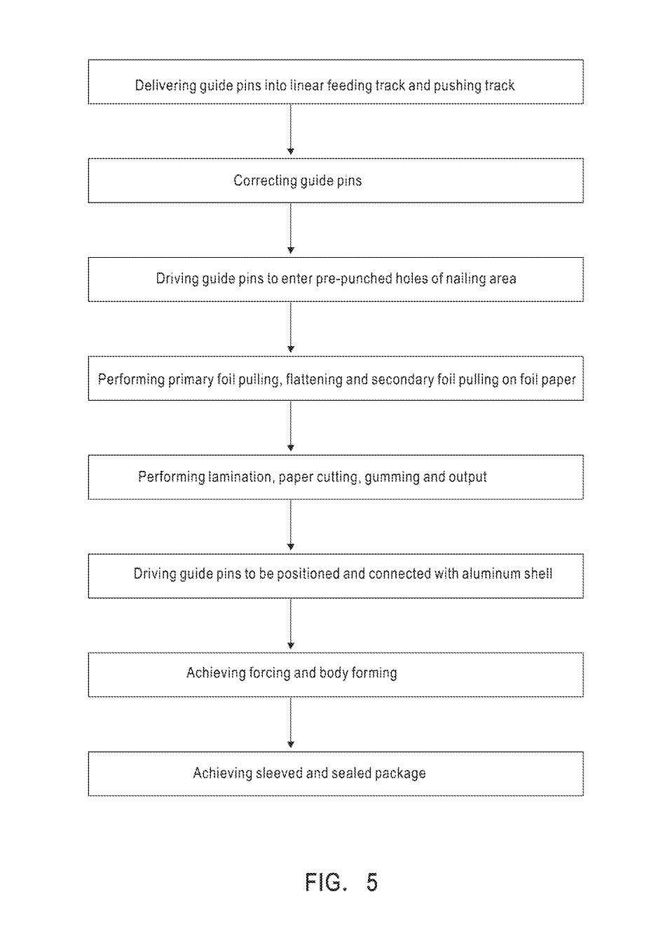

As illustrated in FIGS. 1 to 5, the present invention relates to a lithium battery assembly method, which comprises the following steps of:

(1) arrangement of an assembly system: the assembly system consists of an electrode assembly system, a combining system and a sealing system; a guided transmission device of the electrode assembly system is connected with an automatic feeding device of the combining system; and a feeding channel and a transmission member of the sealing system are connected with the combining system to achieve the process control.

(2) ejection: the electrode assembly system comprises a nailing machine and a nailing machine control module which are configured to correct guide pins and drive the guide pins to enter pre-punched holes of a nailing area to achieve nailing; the nailing machine is also provided with an automatic feed tray to achieve continuous feed and transmission, and a sliding track to achieve the transmission of the guide pins, in which the sliding tack is an adhesive tape; a punch unit is arranged to punch the tails of the guide pins which are hence fixed on a transfer tape; the winder is configured to stack and wind welded positive and negative pole pieces to form a rectangular bare battery core; and an insulating membrane is padded between the positive and negative pole pieces.

(3) winding: the electrode assembly system further comprises a winder and a winder control module which are configured to perform primary foil pulling, flattening, secondary foil pulling and foiling on foil paper, wind the tail of the guide pins after ejection, and perform synchronous lamination, paper cutting, gumming and output; and the winder is provided with a turning and swinging mechanism configured to achieve the pushing transmission of the guide pins, an automatic transfer mechanism configured to achieve the nailing transmission of the guide pins, and an intermediate template configured to achieve the pressing processing of the guide pins and the discharging of nailing pieces and perform foiling, foil feeding and winding on a nailing conjoining body directly or before the discharging.

(4) assembly: the combining system comprises a combiner and a combining controller; an aluminum shell is fixedly connected with the positioned guide pins and hence forced by program control; the guide pins are extended horizontally to form an electrode; the seamless fixed connection between the guide pins and the aluminum shell is achieved to form a battery body structure; and the combiner is provided with a multi-inlet feeding end, a feeding channel and a transmission member configured to respectively achieve the feeding of the aluminum shell and the feeding of an inner core, a plurality of feeding contacts, an execution unit configured to allocate the obtained product to the same executing mechanism through a synchronous control terminal; and hence the synchronous assembly molding can be achieved.

(5) sealing: the sealing system comprises a sleeve device and a sealing machine and further comprises a full-servo control system and a control device; the battery body structure is sleeved into a tubular gel according to the setting scale of the control device; the displacement and the moving cycle are calibrated by the servo control system to control the sealing machine to achieve port sealing; after the sleeve device achieves automatic feeding via an external vibration table, the embedded processing of a sleeve is performed, and the obtained product is sent to an impregnation executing terminal, subjected to vacuum pumping and hence outputted; the sealing machine is provided with a seal on the outside to achieve sealing; the seal is a rubber explosion-proof body; and a small hole through which the electrode penetrates is formed on the explosion-proof body.

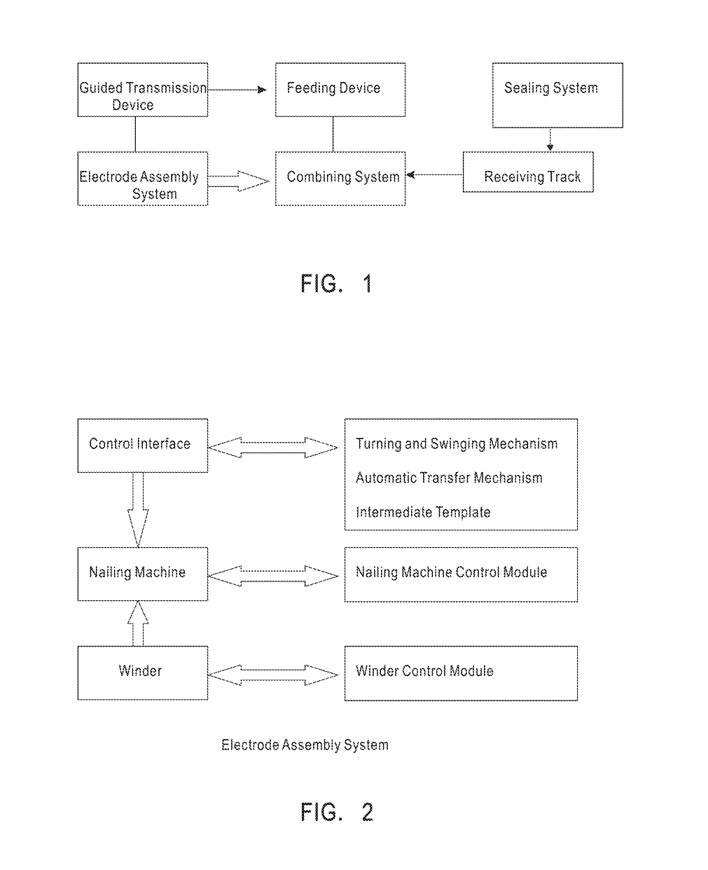

As illustrated in FIG. 2, the present invention relates to an assembly system for achieving the assembly method, which comprises an electrode assembly system, a combining system and a sealing system, wherein a guided transmission device of the electrode assembly system is connected with an automatic feeding device of the combining system; and a feed channel and a transmission member of the sealing system are connected with the combining system to achieve process control.

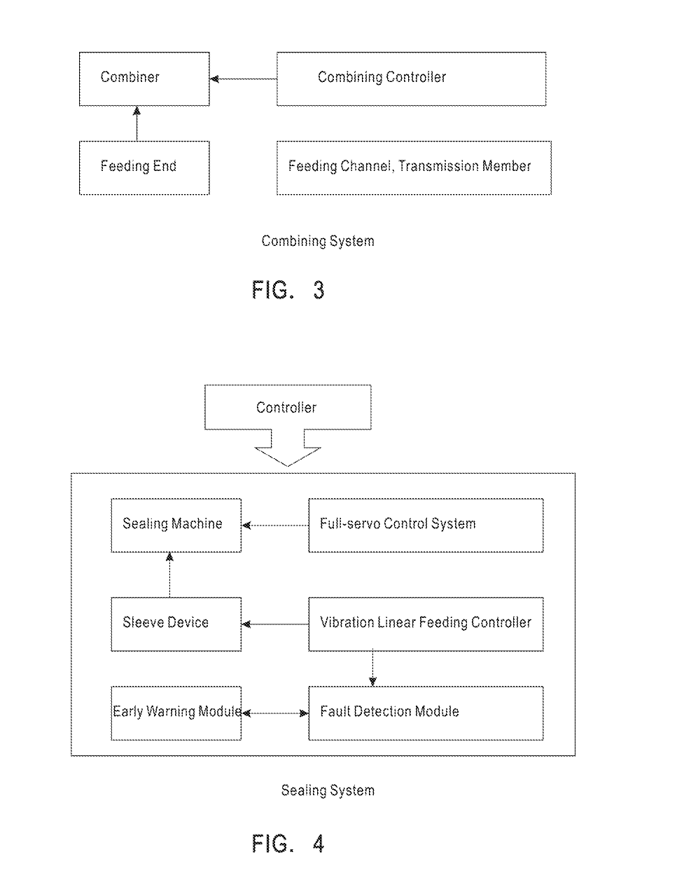

As illustrated in FIG. 3, the electrode assembly system further comprises:

(1) a nailing machine and a nailing machine control module which are configured to deliver guide pins into a linear feeding track and a pushing track in sequence, correct the guide pins and drive the guide pins to enter pre-punched holes of a nailing area to achieve nailing;

(2) a winder and a winder control module which are configured to perform primary foil pulling, flattening, secondary foil pulling and foiling on foil paper, winding tails of the guide pins after ejection, and perform synchronous lamination, paper cutting, gumming and output;

(3) a punch unit configured to punch the tails of the guide pins which are hence fixed on a transfer tape;

(4) a control interface configured to achieve the setting, display and clear of parameters of the nailing machine and provided with a text interface and a numeric keypad;

(5) a turning and swinging mechanism configured to achieve the pushing transmission of the guide pins; an automatic transfer mechanism configured to achieve the nailing transmission; and an intermediate template configured to achieve the pressing processing of the guide pins and the discharging of nailing pieces.

As illustrated in FIG. 3, the combining system further comprises:

(1) a combiner and a combining controller which are configured to achieve the fixed connection and forcing of an aluminum shell and the positioned guide pins by program control so as to form a battery body structure; and

(2) a feeding end configured to achieve the simultaneous feeding of a plurality of ports at the feeding end, with same cycle, in which the feeding end further includes a feed tray, a steel sheet and a support of which the resonance value of the resonance frequency at the maximum amplitude is the same with the magnetic resonance frequency of an electric power source.

As illustrated in FIG. 4, the sealing system further comprises:

(1) a sleeve device and a sealing machine for respectively achieving sleeved arrangement and sealing;

(2) a controller for driving the battery body structure to be sleeved into a tubular gel according to the setting scale;

(3) a full-servo control system for calibrating the displacement and the moving cycle to control the sealing machine to achieve port sealing;

(4) a vibration linear feeding controller for restricting the safe range of the displacement and dimension parameters, in which the vibration linear feeding controller further includes an early warning module and a fault detection module configured to drive the combining system to achieve automatic early warning and stop operating after fault detection.

The lithium battery assembly method provided by the present invention adopts the systematic production mode, and not only saves the resources such as the materials but also saves a large amount of processing time and effectively improves the production efficiency of products via the coherent operations of various assembly systems. In addition, data coupling and synchronous operation are achieved by control systems of various manufacturing processes, so that the process continuity can be strong, and hence the product quality can be effectively improved. Moreover, the appearance and the dimension of products are flexibly set and the technological parameters are quickly converted in view of different application fields, so that the range of use of the products can be maximally widened. Furthermore, as the accessories of cylindrical lithium battery products are precisely combined and the bonding of products and the molding space limit of the main body overcome the extruding defect of the traditional products, the safety hazards such as burning and bursting can be effectively avoided; and as no explosion-proof device is required and only the structure is required to be improved, no production cost and production cycle can be increased.

In the embodiment, when device parameters are modified, a user must enter into a control interface of a control device to be modified, selects parameters to be modified through an option modification window, and inputs relevant parameter values on the basis of clearing the original parameters. In the process, a controller host automatically selects the range of functional parameters. As for the modification of the parameters within the operating range, the controller automatically ignores and the system closes the modification window and executes the original parameters.

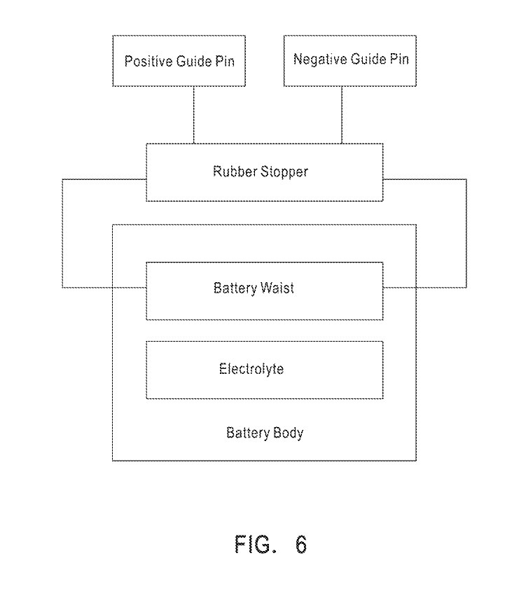

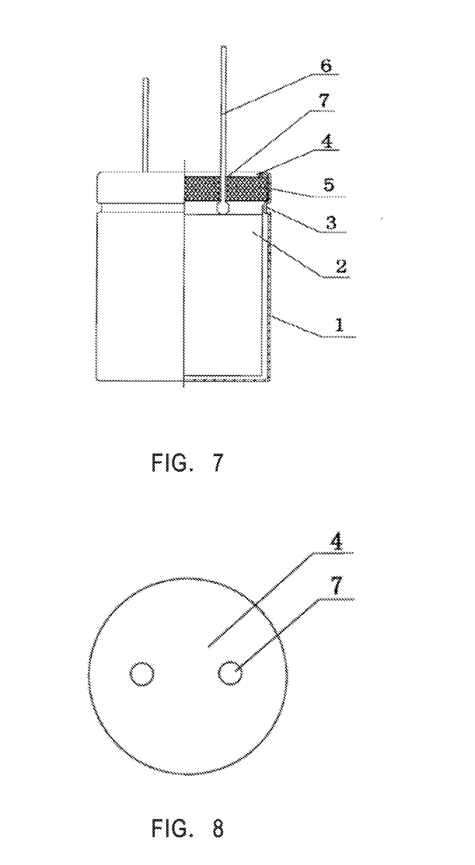

As illustrated in FIGS. 6 and 7, the present invention relates to a positive and negative homopolar explosion-proof lithium battery, which comprises a battery body, wherein the body consists of an aluminum shell 1 disposed on the outside and a battery core 2 and electrolyte disposed on the inside; an outwardly extended electrode is disposed on the battery core 2; a rubber stopper 5 is disposed at an opening of the aluminum shell 1; and the electrode penetrates through the rubber stopper 5.

The electrode consists of two linearly arranged guide pins 6 which are homopolarly and outwardly extended; the rubber stopper 5 is provided with not less than two through holes 7; a seal waist 3 of the battery core 2 is disposed on the upper part of the aluminum shell 1; the rubber stopper 5 is disposed between the seal waist 3 and an opening 4 at the upper end of the aluminum shell 1; the rubber stopper 5 is matched with an independent sleeve, and the shape of the rubber stopper 5 is matched with the shape of the sleeve; and the rubber stopper is configured to seal the sleeve through the static friction between the inner wall of the sleeve and the rubber stopper 5.

As illustrated in FIG. 8, in the embodiment, the assembly of the rubber stopper 5 is as follows:

The present invention adopts the rubber stopper 5 made of rubber materials as a seal of the aluminum shell 1 of the positive and negative homopolar leading-out cylindrical lithium ion battery; the rubber stopper 5 is provided with the two guide pin through holes 7 of the positive and negative guide pins 6 and disposed between the seal waist 3 of the aluminum shell 1 and the opening 4 at the upper end of the aluminum shell; and the two positive and negative guide pins 6 connected to the battery core 2 are led out from the guide pin through holes 7 of the rubber stopper 5. Therefore, not only the positive and negative guide pins 6 can be fixed but also the short circuit caused by the collision of the positive electrode and the negative electrode can be avoided. As the rubber stopper 5 is made of rubber, the battery sealing after electrolyte injection can be also conveniently achieved. In the production process of the lithium ion battery, firstly, the wound positive and negative guide pins 6 of the lithium ion battery core 2 penetrate through the guide pin through holes 7 of the rubber stopper 5; secondly, the battery core 2 provided with the rubber stopper 5 is mounted into the aluminum shell 1; and thirdly, the aluminum shell 1 provided with the battery core 2 and the rubber stopper 5 are sealed by a rolling sealing device after the injection of the lithium ion electrolyte, and the seal waist 3 and the opening 4 of the aluminum shell 1 are formed by rolling at the upper end of the battery core 2 of the aluminum shell 1 and at an end of the aluminum shell 1 respectively, and hence the cylindrical lithium ion battery is processed.

In the positive and negative homopolar explosion-proof lithium battery provided by the embodiment, as the guide pins 6 which are homopolarly led out from the positive electrode and the negative electrode of the cylindrical lithium ion battery are led out from the guide pin through holes 7 of the rubber stopper 5 disposed on the end portion of the battery, not only the guide pins 6 can be fixed but also the short circuit caused by the collision of the positive electrode and the negative electrode can be avoided. Moreover, as the rubber stopper 5 made of the rubber materials is taken as the seal, the battery sealing after electrolyte injection can be also conveniently achieved, and hence the electrical conductivity of the cylindrical lithium ion battery can be guaranteed and the tightness can be also greatly improved. As the rubber stopper 5 is disposed between the seal waist 3 of the aluminum shell 1 and the opening 4 at the upper end of the aluminum shell 1 and the two positive and negative guide pins 6 connected to the battery core 2 are led out from the guide pin through holes 7 of the rubber stopper 5, not only the guide pins 6 can be fixed but also the short circuit caused by the collision of the positive electrode and the negative electrode can be avoided. As the rubber stopper 5 is made of the rubber materials, the battery sealing after electrolyte injection can be also conveniently achieved, and hence the electrical conductivity and the tightness of the cylindrical lithium ion battery can be guaranteed and the product quality can be also greatly improved.

The present invention is not limited to the above embodiments. All the embodiments for achieving the objective of the present invention by adoption of structures and methods similar to the present invention fall within the scope of protection of the present invention.

What is claimed is:

1. A lithium battery assembly method, comprising the following steps of:
(1) arrangement of an assembly system: the assembly system consists of an electrode assembly system, a combining system and a sealing system;
(2) ejection: the electrode assembly system comprises a nailing machine and a nailing machine control module which are configured to correct guide pins and drive the guide pins to enter pre-punched holes of a nailing area to achieve nailing;
(3) winding: the electrode assembly system further comprises a winder and a winder control module which are configured to perform primary foil pulling, flattening, secondary foil pulling and foiling on foil paper, wind tails of the guide pins after ejection, and perform synchronous lamination, paper cutting, gumming and output;
(4) assembly: the combining system comprises a combiner and a combining controller; an aluminum shell is fixedly connected with the positioned guide pins and hence forced by program control; the guide pins are extended horizontally to form an electrode; and the seamless fixed connection between the guide pins and the aluminum shell is achieved to form a battery body structure; and
(5) sealing: the sealing system comprises a sleeve device and a sealing machine and further comprises a full-servo control system and a control device; the battery body structure is sleeved into a tubular gel according to the setting scale of the control device; and the displacement and the moving cycle are calibrated by the servo control system to control the sealing machine to achieve port sealing.

2. The lithium battery assembly method according to claim 1, wherein the steps (1) and (2) further comprise the following steps that:
a guided transmission device of the electrode assembly system is connected with an automatic feeding device of the combining system; a feeding channel and a transmission member of the sealing system are connected with the combining system to achieve the process control; the nailing machine is also provided with an automatic feed tray to achieve continuous feed and transmission, and a sliding track to achieve the transmission of the guide pins, in which the sliding tack is an adhesive tape; a punch unit is arranged to punch the tails of the guide pins which are hence fixed on a transfer tape; the winder is configured to stack and wind welded positive and negative pole pieces to form a rectangular bare battery core; and an insulating membrane is padded between the positive and negative pole pieces.

3. The lithium battery assembly method according to claim 1, wherein the steps (3) and (4) further comprise the following steps that:
the winder is provided with a turning and swinging mechanism configured to achieve the pushing transmission of the guide pins, an automatic transfer mechanism configured to achieve the nailing transmission of the guide pins, and an intermediate template configured to achieve the pressing processing of the guide pins and the discharging of nailing pieces and perform foiling, foil feeding and winding on a nailing conjoining body directly or before the discharging; the combiner is provided with a multi-inlet feeding end, a feeding channel and a transmission member configured to respectively achieve the feeding of the aluminum shell and the feeding of an inner core, a plurality of feeding contacts, an execution unit configured to allocate the obtained product to the same executing mechanism through a synchronous control terminal; and hence the synchronous assembly molding can be achieved.

4. The lithium battery assembly method according to claim 1, wherein the step (5) further comprises the following steps that:
after the sleeve device achieves automatic feeding via an external vibration table, the embedded processing of a sleeve is performed, and the obtained product is sent to an impregnation executing terminal, subjected to vacuum pumping and hence outputted; the sealing machine is provided with a seal on the outside to achieve sealing; the seal is a rubber explosion-proof body; and a small hole through which the electrode penetrates is formed on the explosion-proof body.

5. An assembly system for achieving the assembly method according to claim 1, comprising an electrode assembly system, a combining system and a sealing system, wherein a guided transmission device of the electrode assembly system connected with an automatic feeding device of the combining system; and a feed channel and a transmission member of the sealing system connected with the combining system to achieve process control.

6. The assembly system according to claim 5, wherein the electrode assembly system further comprises:
(1) a nailing machine and a nailing machine control module which are configured to deliver guide pins into a linear feeding track and a pushing track in sequence, correct the guide pins and drive the guide pins to enter pre-punched holes of a nailing area to achieve nailing;
(2) a winder and a winder control module which are configured to perform primary foil pulling, flattening, secondary foil pulling and foiling on foil paper, winding tails of the guide pins after ejection, and perform synchronous lamination, paper cutting, gumming and output;
(3) a punch unit configured to punch the tails of the guide pins which are hence fixed on a transfer tape;
(4) a control interface configured to achieve the setting, display and clear of parameters of the nailing machine and provided with a text interface and a numeric keypad;
(5) a turning and swinging mechanism configured to achieve the pushing transmission of the guide pins; an automatic transfer mechanism configured to achieve the nailing transmission; and an intermediate template configured to achieve the pressing processing of the guide pins and the discharging of nailing pieces.

7. The assembly system according to claim 5, wherein the combining system further comprises:
(1) a combiner and a combining controller which are configured to achieve the fixed connection and forcing of an aluminum shell and the positioned guide pins by program control so as to form a battery body structure; and
(2) a feeding end configured to achieve the simultaneous feeding of a plurality of ports at the feeding end, with same cycle, in which the feeding end further includes a feed tray, a steel sheet and a support of which the resonance value of the resonance frequency at the maximum amplitude is the same with the magnetic resonance frequency of an electric power source.

8. The assembly system according to claim 5, wherein the sealing system further comprises:
(1) a sleeve device and a sealing machine for respectively achieving sleeved arrangement and sealing;
(2) a controller for driving the battery body structure to be sleeved into a tubular gel according to the setting scale;
(3) a full-servo control system for calibrating the displacement and the moving cycle to control the sealing machine to achieve port sealing;
(4) a vibration linear feeding controller for restricting the safe range of the displacement and dimension parameters, in which the vibration linear feeding controller further includes an early warning module and a fault detection module configured to drive the combining system to achieve automatic early warning and stop operating after fault detection.

9. A positive and negative homopolar explosion-proof lithium battery in the method according to claim 1, comprising a battery body, wherein the body consisting of an aluminum shell disposed on the outside and a battery core and electrolyte disposed on the inside; an outwardly extended electrode disposed on the battery core; a rubber stopper disposed at an opening of the aluminum shell; and the electrode penetrating through the rubber stopper and consisting of two linearly arranged guide pins being homopolarly and outwardly extended.

10. The positive and negative homopolar explosion-proof lithium battery according to claim 9, wherein the rubber stopper is provided with not less than two through holes; a seal waist of the battery core is disposed on the upper part of the aluminum shell; the rubber stopper is disposed between the seal waist and an opening at the upper end of the aluminum shell; the rubber stopper is matched with an independent sleeve, and the shape of the rubber stopper is matched with the shape of the sleeve; and the rubber stopper is configured to seal the sleeve through the static friction between the inner wall of the sleeve and the rubber stopper.
